(19) United States
(12) Patent Application Publication
(10) Pub. No.: US 2005/0206047 A1
(43) Pub. Date: Sep. 22, 2005

(54) Contoured circuit boards

(76) Inventor: John Lewison, Wellingborough (GB)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/077,236

(22) Filed: Mar. 10, 2005

(30) Foreign Application Priority Data
Mar. 16, 2004 (GB) 0405888.9

(51) Int. Cl. B29C 43/02

(52) U.S. Cl. 264/553; 29/832

(57) ABSTRACT

A contoured circuit board 1 is manufactured via the steps of providing at least one substrate formed of thermo-plastic material, applying a thermoplastic conductive ink onto the at least one substrate to form conducting tracks 2, and then thermo-forming the at least one substrate into a contoured shape. A pair of such contoured circuit boards are then overlaid, a first contoured circuit board having conducting elements formed on an upper surface and a second contoured circuit board having a complementary shape to, being overlaid on and spaced apart from the first contoured circuit board, said second contoured circuit board having conducting elements formed on a lower surface which faces said upper surface of the first contoured circuit board, whereby pressing of one of said first and second contoured circuit boards towards the other effects contact between the conducting elements formed on the two boards so as to effect an electrical connection therebetween.

The present invention relates to circuit boards having a 3-dimensional or contoured profile and to methods of manufacture thereof.

Circuits are required to be formed upon a substrate which supports the various components in their appropriate positions relative to each other and which provides the wires or tracks which effect the required interconnections between the various components. Conventionally, substrates used for this purpose are either rigid wafers such as silicon, and these are formed as planar wafers on one surface of which the various conducting tracks and electronic components are laid. The drawback of this type of circuit board is that often they are used in areas which are irregularly shaped, which imposes limitations on the size of the planar circuit board which can be located therein. As a result, a circuit which ideally would be laid out on a single circuit board must be produced on a plurality of boards which are interconnected with each other and often located in the mounting area in different planes, at different angles etc in order to make best use of the space available. Such arrangements are, however, complicated to design and expensive to manufacture.

To overcome this problem, circuits have been produced which are formed on a flexible substrate which enables the circuit board to be bent, twisted or possibly even folded to maximise the efficient use of available space. These arrangements have the drawback, however, that there is a limit to minimum radius of curvature through which the flexible substrate can be bent without creases and possibly cracking. Furthermore, the flexible nature of the substrate means that the circuit board is not self-supporting and therefore has to be mounted on a rigid base in order to maintain its required shape and position. This requirement for a rigid base increases the effective size of the circuit board, thereby reducing the available space.

According to the present invention there is provided a method of manufacture of a contoured circuit board comprising the steps of providing a substrate formed of thermoplastic material, applying a thermoplastic conductive ink onto the substrate to form conducting tracks, and then thermo-forming the substrate into a contoured shape.

The present invention further provides a contoured circuit board manufactured according to the method of the invention.

A method of manufacture of a circuit board and a circuit board formed by that method has the advantage that it enables circuit boards to be produced which occupy a minimised space within a product which have the benefit of being self supporting. As a result, the circuit board may be produced such that the substrate forms an integral or even structural part of the product, simplifying the design procedure.

The thermoplastic conductive ink is preferably composed of a conventional conductive ink in a thermoplastic resin. The conductive ink may be applied by screen-printing, drawing, spraying or any other conventional method of applying conductive tracks on circuit boards, and may in conjunction with conductive epoxy bonding and placement of components form active or passive circuits.

The thermo-forming of the substrate is preferably achieved by vacuum forming, although other well-known forming techniques may also be used.

The thermo-formed circuit board may have suitable electronic components fastened on a surface thereon following the forming process, with these components being electrically connected to the conducting tracks in any conventional fashion. Indeed, due to the 3D form of the thermo-formed circuit board, such components can be placed on non-planar surfaces in virtually any orientation, taking into account the physical dimensions of the component.

The circuit board of the invention may also be double sided by applying conducting tracks on both sides of the substrate prior to forming, with interconnections between the sides being provided in a conventional manner. The circuit board may also be multi layered either by laying out multiple flat substrates with the conducting tracks formed thereon and then forming the substrates simultaneously in a single forming step, or by separately forming the layers and overlaying them in their contoured shapes.

The present invention further provides a multi-axis switch comprising a first contoured substrate having conducting elements formed on an upper surface, a second contoured substrate of complementary shape to, overlaying and spaced apart from the first substrate, said second substrate having conducting elements formed on a lower surface which faces said upper surface of the first substrate, whereby pressing of one of said first and second towards the other of the first and second substrates effects contact between the conducting elements formed on the two substrates so as to effect an electrical connection therebetween.

A switch in accordance with the invention has the advantage that the substrates themselves can be used to define the shape of the switch, and also that the switch may be configured to operate in any direction or even in multiple directions. In a particular effective embodiment, the conducting elements on each are formed by multiple conducting tracks, preferably formed of conducting ink, laid out in a mesh. In this way, multiple contact points are provided. The conducting elements may also be laid out with multiple, isolated tracks on each substrate so as to enable switching of multiple separate circuits with a single switch unit by pressing, squeezing or the like at different points or in different directions.

In order that the invention may be well understood, there will now be described an embodiment thereof, given by way of example, reference being made to the accompanying drawing, in which:

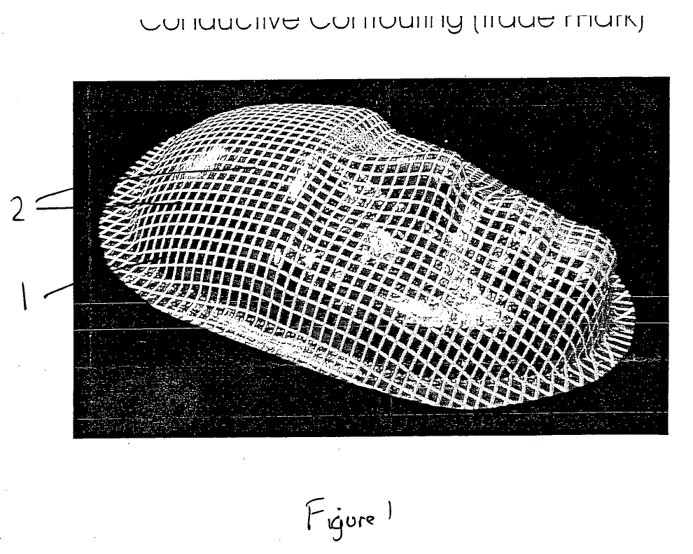

FIG. 1 is a perspective view of a contoured substrate according to the invention with a general conductive track pattern formed thereon;

FIG. 2 is a front view of an embodiment example of a particular circuit formed on a contoured substrate according to the invention; and

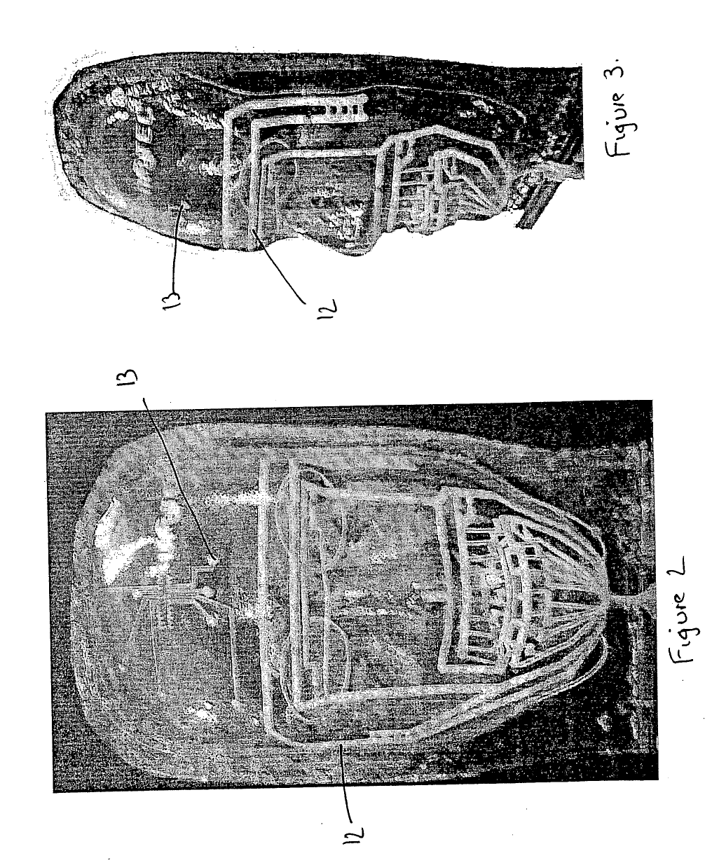

FIG. 3 is a side view of the circuit of FIG. 2.

Referring first to FIG. 1, there is shown a contoured substrate 1 having conducting tracks 2 formed thereon in a mesh pattern. In the illustrated embodiment, the substrate has been formed into the shape of a human face as an example of a particularly complex shape into which a circuit board of the invention maybe formed. However, it will be understood that a wide range of shapes are possible. The tracks 2 provide contact points to which suitable electronic components made be soldered or the like in a convention manner preferably after the forming process but certain components may also be applied prior to contouring of the substrate. The mesh pattern of the tracks shown in FIG. 1 is illustrative only, and it will be understood that the conducting tracks can be laid out in any pattern to meet the requirements of different circuit board designs. Furthermore, in practice, breaks will be provided in the tracks which will be bridged by the required electronic components.

FIGS. 2 and 3 show developed versions of the contoured substrate of FIG. 1 have the conducting tracks 12 paid out to form an actual circuit including contact points 13 for connection of circuit components, connectors and the like.

1. A method of manufacturing a contoured circuit board comprising the steps of providing at least one substrate formed of thermo-plastic material, applying a thermoplastic conductive ink onto the at least one substrate to form conducting tracks, and then thermo-forming the at least one substrate into a contoured shape.

2. A method of manufacturing a contoured circuit board according to claim 1, wherein the thermoplastic conductive ink is composed of a conventional conductive ink in a thermoplastic resin.

3. A method of manufacturing a contoured circuit board according to claim 1, wherein the substrate is contoured by vacuum forming.

4. A method of manufacturing a contoured circuit board according to claim 1, comprising the further step of fastening electronic components onto a surface of the circuit board, following the forming process, and electrically connecting said components to the conducting tracks.

5. A method of manufacturing a contoured circuit board according to claim 4 wherein the electronic components are positioned in conjunction with conductive epoxy resin to form active circuits.

6. A method of manufacturing a contoured circuit board according to claim 4 wherein the electronic components are positioned in conjunction with conductive epoxy resin to form passive circuits.

7. A method of manufacturing a contoured circuit board according to claim 1, wherein conductive tracks are applied on both sides of the substrate prior to said thermo-forming operation.

8. A method of manufacturing a contoured circuit board according to claim 1, wherein the thermo-forming process involves laying out multiple flat substrates, with the conducting tracks formed thereon, and then forming the substrates simultaneously in a single forming step.

9. A method of manufacturing a contoured circuit board according to claim 1, wherein the thermo-forming process is carried out on separate substrate layers, with the conducting tracks formed thereon, which are then overlaid in their contoured shapes.

10. A contoured circuit board manufactured according to claim 1.

11. A multi-axis switch comprising a first and a second contoured circuit board according to claim 10, the first contoured circuit board having conducting elements formed on an upper surface and the second contoured circuit board having a complementary shape to, being overlaid on and spaced apart from the first contoured circuit board, said second contoured circuit board having conducting elements formed on a lower surface which faces said upper surface of the first contoured circuit board, whereby pressing of one of said first and second contoured circuit boards towards the other effects contact between the conducting elements formed on the two boards so as to effect an electrical connection therebetween.

12. A multi-axis switch according to claim 11, wherein the conducting elements are formed by multiple conducting tracks laid out in a mesh.

13. A multi-axis switch according to claim 12, wherein the conducting tracks are formed of conducting ink.

14. A multi-axis switch according to claim 11, wherein the conducting elements are laid out with multiple, isolated tracks on each substrate.
